(19) United States
(12) Patent Application Publication
(10) Pub. No.: US 2008/0208975 A1
(43) Pub. Date: Aug. 28, 2008

(54) Methods, systems, and computer program products for accessing a discussion forum and for associating network content for use in performing a search of a network database

(76) Inventor: Bentley J. Olive, Apex, NC (US)

Correspondence Address: Bentley J. Olive, 453 Black Willow Drive, Apex, NC, 27523, US

(21) Appl. No.: 11/710,127

(22) Filed: Feb. 23, 2007

(51) Int. Cl. G06F 15/16

(52) U.S. Cl. 709/205

(57) ABSTRACT

Methods, systems, and computer program products for accessing a discussion forum and for associating network content for use in performing a search of a network database are disclosed. According to one aspect, a method can include receiving identification of a subject from a client device. Further, the method can include receiving selection of at least one of a plurality of predetermined discussion forum categories for accessing a discussion forum associated with the identified subject and the at least one of the plurality of predetermined discussion forum categories. The method can also include presenting a discussion forum to the client device based on the received identification of the subject and the received selection of the at least one of the plurality of predetermined discussion forum categories.

### TECHNICAL FIELD

The subject matter described herein relates to discussion forums and network database searching. More particularly, the subject matter described herein relates to methods, systems, and computer program products for accessing a discussion forum and for associating network content for use in performing a search of a network database.

### BACKGROUND

A discussion forum is any suitable facility for holding discussions between users of a communications network or for presenting content made available by a single user. Some examples of discussion forums include a message forum, a wiki, a chat room, a weblog (“blog”) and instant messaging. The Internet is populated with many discussion forums, although discussion forums can be made available via any suitable communications network, such as a mobile telephone network, a local area network (LAN), or intranet.

In one example, a discussion forum can be managed by a web server accessible via the Internet. The web server can provide a website configured to manage a number of discussion forums that each includes one or more entries entered by one or more users. Each entry can include, for example, text, images, video, and/or links for forming a discussion in the form of a series of user-entered posts. Further, a discussion forum can be a single entry that is written by a single user. Users can post entries to a discussion forum or initiate a discussion forum by user of a client device.

Communications networks can include various types of content accessible by its users. For example, content available on communications networks can include text, images, videos, and/or links. Typically, users may desire to initiate or join a discussion forum directed to the content. In one example, a user may initiate or join a discussion forum directed to the content by accessing a website configured to host a discussion forum. In this example, the user may input a name of the content in a description of the discussion forum such that other users may be able to determine whether to access the discussion forum. In another example, a webpage can include a link to a discussion forum about the webpage. For example, a news-related webpage may include a hyperlink to a discussion forum for the webpage.

Currently, users find discussion forums by going directly to a source hosting the discussion forum (e.g., a webpage hosting a discussion forum). Alternatively, users can find discussion forums by using a search engine for searching through cached network content for the discussion forum. These techniques can be difficult and inconvenient to a user for finding a desired discussion forum. It would be beneficial to provide for an easier and more convenient technique by which a user can join or initiate a discussion forum that is easily discovered by other users.

Many search techniques have been developed for finding network content available on a network. For example, Internet search services provide for searching network content in a network database based on words and/or phrases. Exemplary Internet search services are provided by the GOOGLE™ search engine (available from Google Inc., of Mountain View, Calif.) and the YAHOO!® search engine (available from Yahoo! Inc., of Sunnyvale, Calif.). Further, websites are available whereby users can recommend and rate other websites. It would be beneficial to provide a technique by which user entries with respect to network content (e.g., websites or webpages) are used for organizing a network database containing network content for search.

Accordingly, in light of the above described difficulties and needs associated with discussion forums and with searching network content, there exists a need for improved methods, systems, and computer program products for accessing discussion forums and for performing a search of a network database.

### SUMMARY

According to one aspect, the subject matter described herein includes methods, systems, and computer program products for accessing a discussion forum. One method includes receiving identification of a subject from a client device. Selection of at least one of a plurality of predetermined discussion forum categories can be received for accessing a discussion forum associated with the identified subject and the at least one of the plurality of predetermined discussion forum categories. Further, a discussion forum can be presented to the client device based on the received identification of the subject and the received selection of the at least one of the plurality of predetermined discussion forum categories.

According to another aspect, the subject matter described herein includes methods, systems, and computer program products for associating network content for use in performing a search of a network database. One method includes receiving input from a client device that identifies network content and that associates the identified network content with at least one of a plurality of predetermined discussion forum categories. Further the at least one of the plurality of predetermined discussion forum categories can be associated with network content in a network database. The identified network content can be associated with the network content in the network database based on the at least one of the plurality of predetermined discussion forum categories for use in a search of the network database.

According to another aspect, the subject matter described herein includes methods, systems, and computer program products for identifying a discussion forum associated with a subject related to a subject identified by a client device. One method includes associating a first subject with a discussion forum. Identification of a second subject can be received from a client device. The at least one of content and metadata of the first subject can be compared with at least one of content metadata of the second subject for relating the first subject to the second subject. The discussion forum associated with the first subject can be identified to the client device based on the relation of the first subject and the second subject. As used herein, the term “discussion forum” refers to any suitable facility for holding discussions between users of a communications network or for presenting content made available by a single user. Exemplary discussion forums include a message forum, a wiki, a chat room, a weblog (“blog”) and instant messaging. In one example, a discussion forum may be maintained by a website where entries into the forum are made by one or more users. In one example, the entries may be entered in journal style and displayed in a reverse chronological order. Discussion forums may be based on a particular subject such as food, politics, or local news. Further, discussion forums may include photographs (photoblog), videos (vlog), or audio (podcasting). Discussion forums may function as personal online diaries. A discussion forum and/or its entries may include text, images, and links to other discussion forums, webpages, and other media related to its topic.

As used herein, the term “client device” refers to any suitable electronic device for communicating with a server via a network. Exemplary client devices include a mobile phone, a PDA, a network component, a television, a computer, and a device configured to implement a web portal.

As used herein, the term “network database” refers to any suitable collection of content (also referred to as “data”) associated with a database. The database may be stored in a single memory component or distributed among a plurality of components in a network. Exemplary data in the network database includes image content, video content, audio content, text content, links, metadata, and/or any other content suitable for storage on a memory component. In one example, the data may include all or a portion of the content accessible via the Internet.

As used herein, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

### BRIEF DESCRIPTION OF THE DRAWINGS

Preferred embodiments of the subject matter described herein will now be explained with reference to the accompanying drawings of which:

FIG. 1 is a block diagram of an exemplary system for accessing a discussion forum according to an embodiment of the subject matter described herein;

FIGS. 2A and 2B are a flow chart of an exemplary process for accessing a discussion forum according to an embodiment of the subject matter described herein;

FIG. 3 is a screen display of an exemplary webpage including predetermined discussion forum categories corresponding to an identified subject according to an embodiment of the subject matter described herein;

FIGS. 4A and 4B are a flow chart of an exemplary process for selecting a messaging category according to an embodiment of the subject matter described herein;

FIG. 5 is a flow chart of an exemplary process for identifying a discussion forum associated with a subject related to a subject identified by a client device according to an embodiment of the subject matter described herein; and

FIG. 6 is a flow chart of an exemplary process for associating network content for use in performing a search of a network database according to an embodiment of the subject matter described herein.

### DETAILED DESCRIPTION

The subject matter described herein includes methods, systems, and computer program products for accessing a discussion forum and for associating network content for use performing a search of a network database. According to one aspect, a system according to the subject matter described herein may be implemented as hardware, software, and/or firmware components executing on one or more components of a system configured to allow a user to interact with a discussion forum. In particular, a system in accordance with the subject matter described herein can allow a user, via a client device, to access a discussion forum. For example, the subject matter described herein can allow a user to identify a discussion forum, to view a discussion forum, to add an entry to a discussion forum, and/or to initiate a discussion forum. In one example, the identification of a discussion forum can include receiving, via a client device, an identifier of the discussion forum and/or information relating to the discussion forum, such as its content or metadata associated with the discussion forum. In this example, the received identifier of the discussion and/or information relating to the discussion forum can be displayed to a user via the client device. In one example, the viewing of a discussion forum can include displaying discussion forum entries via a client device. In one example, an entry to a discussion forum can include the adding of content to the discussion forum by a user via a client device. In one example, the initiation of a discussion forum can include one of adding of a first entry into a discussion forum via a client device and/or identifying the subject and category of a discussion forum.

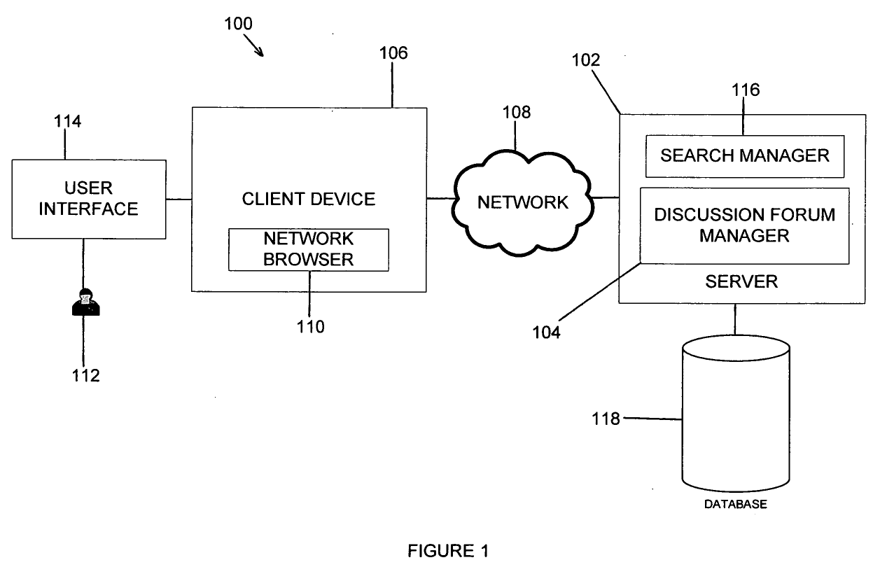

FIG. 1 is a block diagram of an exemplary system 100 for accessing a discussion forum according to an embodiment of the subject matter described herein. Referring to FIG. 1, system 100 may include a server 102 including a discussion forum manager 104 configured to manage discussion forums for one or more client devices. For example, discussion forum manager 104 can be configured to manage a discussion forum for a client device 106. Exemplary discussion forums include a message forum, a wiki, a chat room, a weblog (“blog”) and instant messaging (IM). Server 102 and client device 106 are configured to communicate with each or other network components via a network 108. For example, server 102 and 106 may be configured to communicate using Internet protocol (IP) via network 108.

Client device 106 can include a network browser 110 configured to access content available via network 108 and present the content to a user 112 of client device 106. For example, network 108 can be the Internet, and network browser 110 can be a web browser configured to access webpages and websites accessible via the Internet. Network browser 110 can be configured to present such content such as documents, video, images, and other suitable media available a network. Further, network browser 110 can be configured to receive input for searching network content and configured to communicate data via network 108. Network browser 110 can provide an interface between client device 106 and a discussion forum available via network 108.

Client device 100 can include a user interface 114 configured to receive input from user 112 and configured to present output to user 112. For example, user interface 114 can include a suitable input device such as a mouse, a keyboard, a touchscreen, and/or a voice input device. In another example, user interface 114 can include a suitable output device such as a display, one or more speakers, and/or a printer. User interface 114 can be used to input data to network browser 110 and to receive data from network browser 110 for facilitating interface between user 112 and devices in communication with network 108 and discussion forums available via network 108.

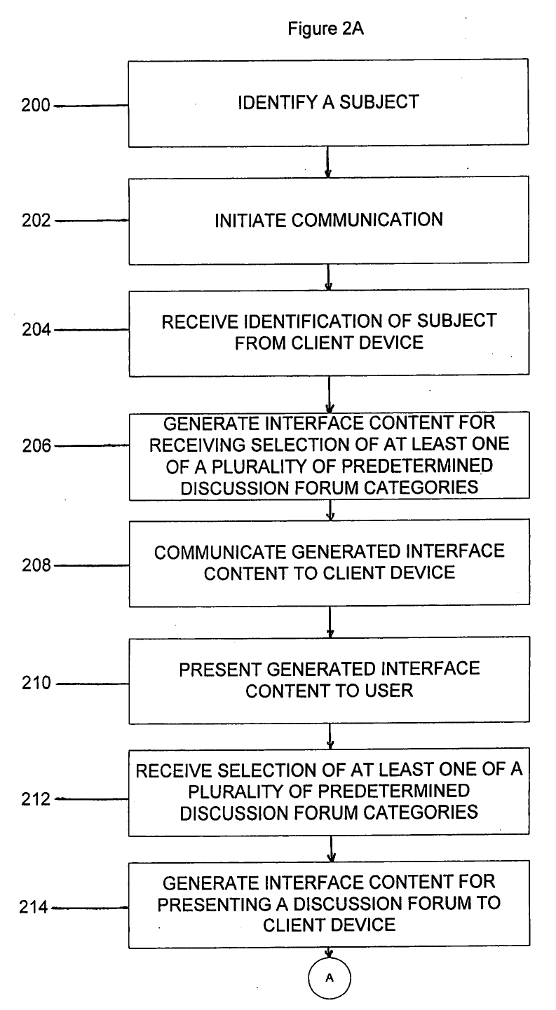

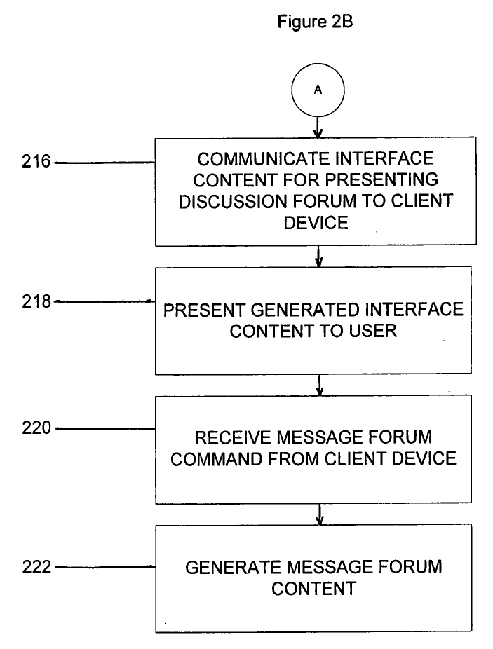

FIGS. 2A and 2B are a flow chart of an exemplary process for accessing a discussion forum according to an embodiment of the subject matter described herein. Referring to FIG. 2A, in block 200 user 112 can enter input into user interface 114 to identify a subject for a discussion forum. User 114 may enter input via user interface 114 for identifying one of at least a portion of a website, audio content, text content, video content, photo content, at least a portion of a periodical, a product, a geographic location, and network content. In one example, a website may be identified by using network browser 110 to access media content available via network 108. In this example, the website can include one or more of text, an image, and a video that can be selected or highlighted via user interface 114. In another example, a subject, such as media content, stored on client device 106 can be identified by using any suitable application. In this example, the subject can be identified by a file name and stored within a folder in a database of client device 106. Further, exemplary subject identifications can include a uniform resource location (URL), a title of music content, a title of video content, a title of a photo, a title of a periodical, a title of a periodical article, a product name, a product uniform product code (UPC), and a name of a geographic location.

In block 202, client device 106 can initiate communication with server 102. For example, server 102 can maintain a website accessible by client device 106 via network 108. User 114 can enter input for controlling network browser 110 to access the website. One or more webpages of the website can be displayed to user 114 via a display of user interface 114.

In block 204, discussion forum manager 104 can receive identification of the subject from client device 106. In one example, a webpage maintained by server 102 can be configured to receive identification of the subject from client device 106. In this example, user 114 may enter input into the webpage maintained by server 102 for identifying the subject. For example, the subject may be a website, the subject website can be identified by entering a URL into the website maintained by server 102. The URL of the website may be entered into a text box of the website maintained by server 102. Next, the entered URL can be communicated to server 102 via Internet 108. Thus, in the example, the entered URL identifies a subject for discussion forum manager 104.

In another example of receiving identification of the subject from client device 106, user 114 can access a subject webpage via network browser 110. The accessed webpage can be presented to user 114 in a window displayed via a display of user interface 114. The URL of the subject webpage can be displayed in an address box of the displayed browser window. For example, the subject webpage can be a webpage of interest such as an automobile review article. In this example, the following URL can be presented in the address box: http://www.edmunds.com/apps/vdpcontainers/do/vdp/articleId=116429/pageNu mber=1. In this example, the automobile review article webpage is the subject. The subject can be identified to the webpage maintained by server 102 by entering the URL into a text box of the maintained webpage. Alternatively, an URL of the webpage maintained by server 102 can be inserted as a prefix to the URL of the subject webpage. For example, the webpage maintained by server 102 can be www.examplewebpage.com, which can be entered as a prefix as follows: http://www.examplewebpage.com/www.edmunds.com/apps/vdpcontainers/do/vdp/articleId=116429/pageNumber=1. User 112 can enter the URL with the prefix into user interface 114 can communicate the URL with the prefix to server 102. Server 102 can receive the URL and extract the subject website URL. Discussion forum manager 104 can be configured for receiving the URL as the subject identified by client device 106.

In response to receiving the identification of the subject from client device 106, discussion forum manager 104 can generate interface content for receiving selection of at least one of a plurality of predetermined discussion forum categories from client device 106 (block 206). For example, manager 104 can generate a webpage identifying the subject and predetermined discussion forum categories. Exemplary discussion forum categories include arts, automobiles, beauty, computers, crafts, economy, education, entertainment, film, repair, food, games, politics, history, philosophy, housing, jobs, sports, travel, television, science, music, news, selling, local, and reviews. Each of the categories can be displayed as a word on the webpage and associated with a respective hyperlink. Further, the generated webpage can include a number that is associated with each of the categories for indicating the number of discussion forums or discussion forum entries that correspond to the identified subject and the respective category. For example, a discussion forum corresponding to the subject of the automobile review webpage can have 25 entries for the reviews category. In this example, the generated webpage has the number 25 adjacent a reviews category indicia for indicating that 25 entries have been entered in a discussion forum corresponding to the subject of the automobile review webpage.

In one embodiment, user 112 can identify more than one subject. The identification of the subjects can be received by discussion forum manager 104. In response, discussion forum manager 104 can generate interface content for receiving selection of a plurality of predetermined discussion forum categories. The interface content can be communicated to the client device and presented to the user. The user can select at least one of the predetermined discussion forum categories. Next, discussion forum manager 104 can generate interface content for presenting a discussion forum to the client device. Interface content for presenting the discussion forum to the client device. Discussion forum manager 104 can receive a message forum command from the client device and generate message forum content based on the command.

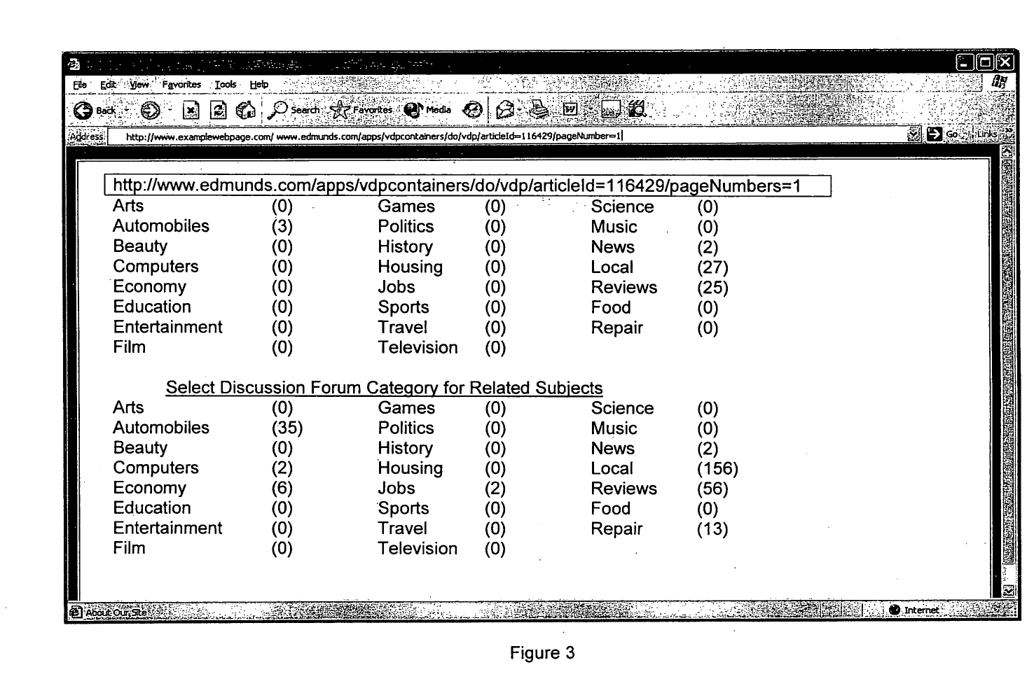

FIG. 3 illustrates a screen display of an exemplary webpage including predetermined discussion forum categories corresponding to an identified subject according to an embodiment of the subject matter described herein. Referring to FIG. 3, the subject is a webpage associated with the above described automobile review. The discussion forum categories under the heading “Select Discussion Forum Category for Subject” (and above the heading “Select Discussion Forum Category for Related Subjects”) are the discussion forum categories corresponding to the identified subject. Three discussion forum entries have been entered for the subject webpage and in the discussion forum category of automobiles. Two discussion forum entries have been entered for the subject webpage and in the discussion forum category of News. Ninety-five discussion forum entries have been entered for the subject webpage and in the discussion forum category of Selling. Twenty-seven discussion forum entries have been entered for the subject webpage and in the discussion forum category of Local. Twenty-five discussion forum entries have been entered for the subject webpage and in the discussion forum category of Reviews.

Referring again to FIG. 2, in block 208, the generated interface content can be communicated to client device 106. For example, the generated interface content can be a webpage as described above and communicated to client device 106 via network 108. Client device 106 can receive the generated interface content and present the generated interface content to user 112 via user interface 114 (block 210). For example, the webpage shown in FIG. 3 can be presented to user 112 via a display of user interface 114.

In block 212, discussion forum manager 104 can receive selection of at least one of the predetermined discussion forum categories from client device 106 for accessing a discussion forum associated with the identified subject and the at least one of the plurality of predetermined discussion forum categories. For example, one of the categories on the above described exemplary generated webpage can be selected by user 112 by user of user interface 114. A category can be selected by clicking on a hyperlink on the webpage that corresponds to the predetermined discussion forum category. For example, the user can select the hyperlinked text of the Reviews discussion forum category shown in FIG. 3. By this selection, user 112 can enter the discussion forum, view content of the discussion forum, and/or search the content of the discussion forum. Alternatively, the user can select the hyperlinked text of the Economy discussion forum category shown in FIG. 3. By this selection, user 112 can initiate a new discussion forum associated with the subject and the Economy discussion forum category. Client device 106 can communicate the selection to network 108 for receipt by discussion forum manager 104.

In response to receiving the selection of the predetermined discussion forum category, discussion forum manager 104 can generate interface content for presenting a discussion forum to client device 106 based on the received identification of the subject and the received selection of the predetermined discussion forum category. In one example, a discussion forum category corresponding to the identified subject and the selected predetermined forum category can be associated with an existing discussion forum category. In this example, manager 104 may generate interface content by which client device can enter the discussion forum and/or viewing content of the discussion forum. The generated interface content can be in the form of a webpage. In another example, a discussion forum category corresponding to the identified subject and the selected predetermined forum category is not associated with an existing discussion forum. In this example, manager 104 may generate interface content by which client device 106 can start a new discussion forum corresponding to the received identification of the subject and the received selection of the predetermined discussion forum category. The generated interface content can be in the form of a webpage. Other users can communicate with server 102 for viewing the discussion forum, searching the discussion forum, and/or contributing content to the discussion forum.

Referring to FIG. 2B, in block 216, the generated interface content for presenting the discussion forum to client device 106 can be communicated to client device 106. For example, the generated interface content can be a webpage as described above and communicated to client device 106 via network 108. In one example, the interface content can include a listing of entries associated with the received identification of the subject and the received selection of the predetermined discussion forum category. Client device 106 can receive the generated interface content and present the generated interface content to user 112 via user interface 114 (block 218).

In block 220, client device 106 can receive discussion forum command input for viewing a discussion forum if a discussion forum exists, searching a discussion forum if a discussion forum exists, contributing content to a discussion forum if a discussion forum exists, and/or creating a new discussion forum. For example, a discussion forum entry can be received for entry into a message forum. The received discussion forum command can be communicated to discussion forum manager 104.

Based on the command, manager 104 can generate message forum content (block 222). For example, manager 104 can generate a new message forum corresponding to the identified subject and the selected predetermined forum category. In another example, manager 104 can create a new entry in a message forum corresponding to the identified subject and the selected predetermined forum category. In another example, manager 104 can search content in a message forum corresponding to the identified subject and the selected predetermined forum category. In another example, manager 104 can view entries in a message forum corresponding to the identified subject and the selected predetermined forum category.

In one embodiment, client device 106 can be configured to automatically determine whether a discussion forum exists for a subject when the subject is identified by user 114. For example, each time user 114 selects a webpage for viewing, client device 106 can be configured to automatically communicate the identified webpage to server 102 for determining whether one or more discussion forums exist for the subject. Further, server 102 can determine the predetermined discussion forum categories having entries for the identified subject. Server 102 can communicate information to client device 102 for indicating the discussion forums for the subject. User 114 can then decide to enter one of the discussion forums and use client device 106 to access server 102 for accessing one or more of the discussion forums, viewing content of one or more of the discussion forums, and/or searching the content of one or more of the discussion forums. In this way, user 114 does not have to manually search for the existence of discussion forums each time a subject is identified. Client device 106 can include a plugin application configured to initiate the automatic determination of whether a discussion forum exists for a subject when the subject is identified by user 114.

In one embodiment, discussion forum manager 104 can associate a message forum corresponding to the identified subject and the selected predetermined forum category to one or more other related discussion forums. For example, another discussion forum having the same or a related predetermined forum category can be associated with the message forum. In another example, a discussion forum having similar content entries can be associated. For example, the discussion forums can be determined to be associated if the discussion forums contain the same or similar media content, such as text, video, and images. The discussion forums that are associated can be identified to client device 106 and presented to user 112 via user interface 114. Client device 106 and manager 104 can be configured to provide for user 112 to view or search the associated discussion forums. These associated discussion forums can be identified or presented to client device 106, for example, in the process of blocks 214 and 216.

In another example, an associated discussion forum can also include a discussion forum having the same identified subject or a similar identified subject. For example, the identified content of two or more discussion forums can correspond to an article or article subject that is similar. For example, two different identified subject webpages can be about a review of a Chevrolet Tahoe automobile. Manager 104 can be configured to analyze the text or images in the webpage for determining that the subject webpages are similar. The discussion forums that are associated can be identified to client device 106 and presented to user 112 via user interface 114. Client device 106 and manager 104 can be configured to provide for user 112 to view or search the associated discussion forums. These associated discussion forums can be identified or presented to client device 106, for example, in the process of blocks 214 and 216.

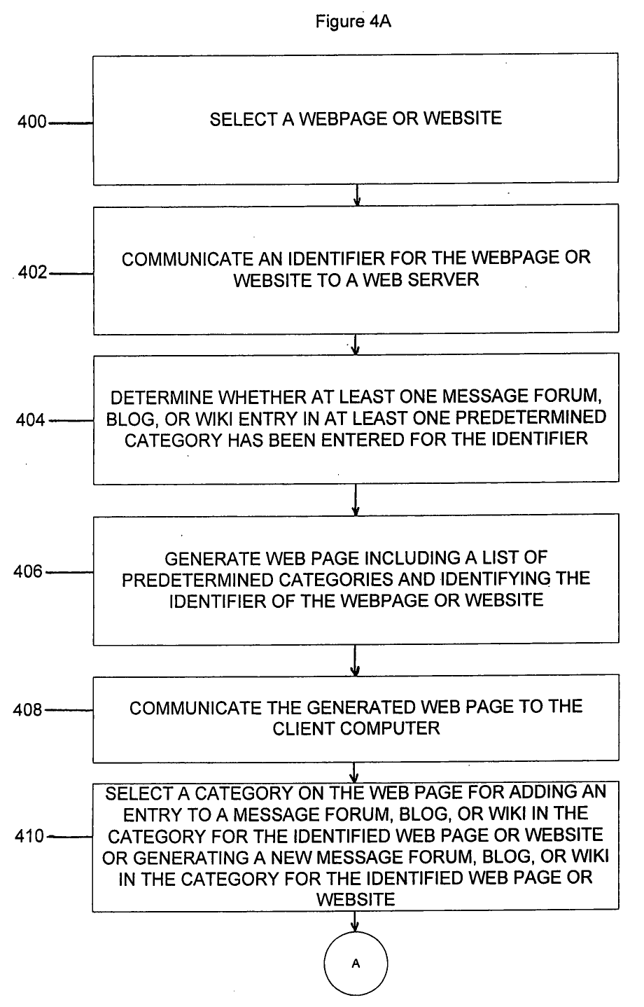

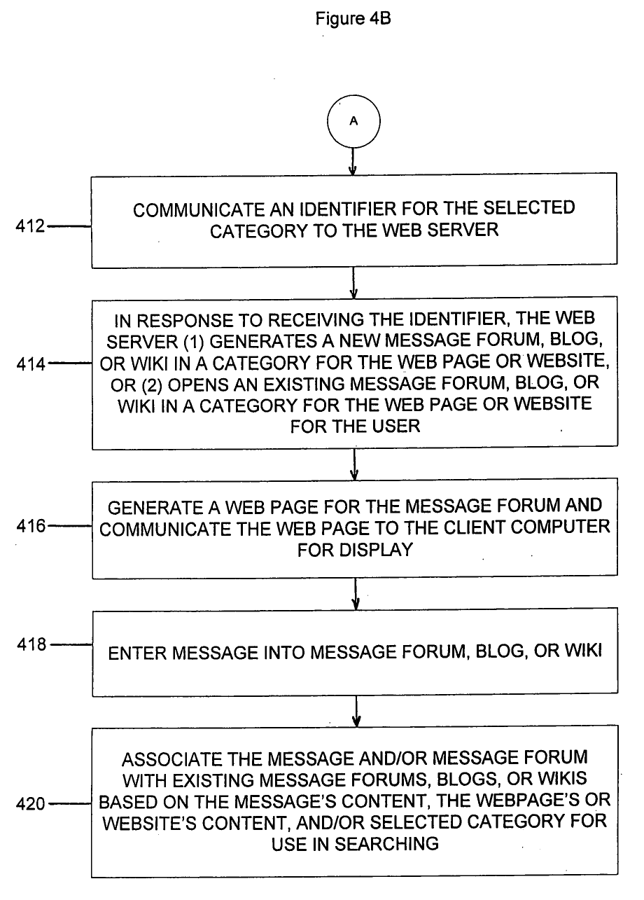

FIGS. 4A and 4B are a flow chart illustrating an exemplary process for selecting a messaging category according to an embodiment of the subject matter described herein. Referring to FIG. 4A, a computer user selects a webpage or website (block 400). For example, a computer user may select a webpage or website by inputting an identifier for a webpage or website into a web browser. An exemplary webpage or website identifier is a uniform resource locator (URL). The entered webpage or website may contain content, such as text and/or media content, in which the computer user is interested. The computer user may desire to initiate or join a messaging forum or web log associated with the selected webpage or website and in one or a predetermined category.

In block 402, an identifier for the webpage or website is communicated to a web server. In one example, a computer may display a webpage managed by the web server on a computer being used by the computer user. The displayed webpage may include a text entry box in which the user can enter the identifier for the webpage or website. In another example, a user may enter the website or webpage URL as a postfix to a URL of the web server (e.g., the user may user may enter into a web browser the following http://www.webmessageforum.com/www.edmunds.com/TahoeReview/, where the www.webmessageforum.com portion corresponds to the service and the www.edmunds.com/TahoeReview corresponds to the URL of a webpage article of interest).

In block 404, the web server determines whether at least one entry of a message forum, blog, and/or wiki in at least one predetermined category has been entered for the identifier. For example, the web server can maintain a plurality of categories in which a message forum can be created for an identified website or webpage. In this example, the web server may determine whether any of the categories has an entry.

In block 406, the web server generates a webpage including a list of predetermined categories and identifying the identifier the identifier of the webpage or website. For example, the generated webpage can identify the webpage www.edmunds.com/TahoeReview. Further, for example, the webpage can include a listing of categories, such as Product Review, Sports, Entertainment, Movie Review, Politics, Local, News, Financial, Books, and Classifieds. The webpage can also provide a number of the message forums associated with each category for the webpage. In this example, the Product Review and Classifieds categories can have several entries, but the Sports category may have no entries. The categories can be generic for each webpage. In other words, the categories should cover every subject, but function to help organize the website/webpage and the messages entered for the website/webpage. The categories listed on the generated webpage can be hyperlinks to a page for adding an entry to a message forum in the corresponding category or creating a message forum in the corresponding category.

In block 408, the generated webpage may be communicated to the user's computer for display. For example, the generated webpage can be communicated to the user's computer via the Internet for presentation via a display.

In block 410, the user may either (1) select one of the categories on the displayed webpage for adding an entry to an existing message forum, blog, or wiki in the selected category, or (2) select one of the categories on the displayed webpage for creating an entry in a new message forum, blog, or wiki in the selected category. For example, the user may select the Product Review category for starting a new message forum containing comments on Tahoe reviews associated with the www.edmunds.com/TahoeReview website. In one example, the selected category may be associated with two hyperlinks, wherein one hyperlink is for joining one of a plurality of different message forums and one hyperlink is for creating a new message forum.

Referring to FIG. 4B, in block 412, an identifier for the selected category is communicated to the web server. For example, the identifier can indicate to join one of the existing message forum or the start a new message forum.

In block 414, in response to receiving the identifier, the web server (1) generates a new message forum, blog, or wiki in a category for the webpage or website, or (2) opens an existing message forum, blog, or wiki in a category for the webpage or website for the user. For example, the web server may open a new message forum in the Product Review category for the www.edmunds.com/TahoeReview website.

In block 416, the web server generates a webpage for the message forum and communicates the webpage to the user's computer for display. For example, the identifier can indicate to join one of the existing message forum or the start a new message forum.

In block 418, the user enters a message into the computer and the message forum, blog, or wiki is communicated to the web server for posting.

In block 420, the web server associates the message and/or message forum with existing message forums, blogs, or wikis based on the message's content, the webpage's or website's content, and/or selected category for use in searching. For example, a user may search for message forums by using keywords. In this example, this is a way for a user to join a forum without identifying a website and/or webpage.

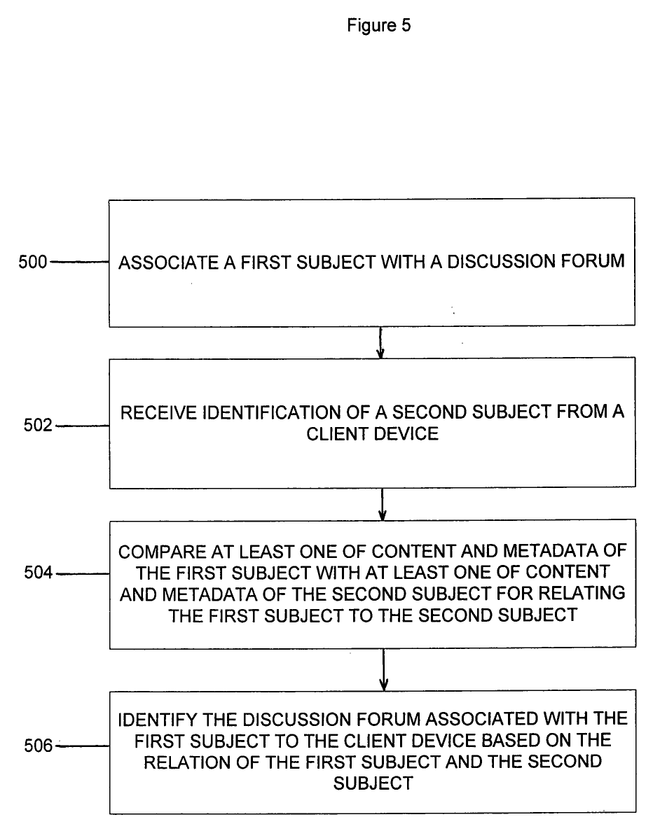

In one embodiment, a discussion forum manager can be configured to identify discussion forums associated with one or more subjects that are related to a subject identified by a client device. FIG. 5 is a flow chart of an exemplary process for identifying a discussion forum associated with a subject related to a subject identified by a client device according to an embodiment of the subject matter described herein. Referring to FIG. 5, in block 500 discussion forum manager 104 can associate a subject with a discussion forum. For example, manager 104 can associate a webpage identified by a client device with a discussion forum in accordance with the examples provided herein.

In block 502, manager 104 can receive identification of a subject from client device 106. For example, in reference to the above example of an automobile review webpage, the automobile review webpage can contain content of a review of a particular model and year of an automobile. In this example, the subject identified by client device 106 and the subject associated with the discussion forum do not contain the entirely same content and/or metadata, but can include similar content and/or metadata or can include portions of content and/or metadata that are the same.

In block 504, manager 104 can compare at least one of content and metadata of the subject associated with the discussion forum and at least one of content and metadata of the subject identified by client device 106. For example, manager 104 can be configured to obtain the content and/or metadata of both subjects and compare them. Further, for example, manager 104 can be configured to analyze the text and/or images of the webpage and determine webpages or other suitable subjects related to the identified automobile review webpage. In one example, manager 104 can extract the name of the particular automobile associated with the webpage and identify webpages or subjects including the name or associated with the name. If the subjects are determined to have at least some of the same content, the subjects are determined to be related. In one example, a predetermined amount of content of the subjects must be the same for the subjects to be deemed to be related. Further, in one example, manager 104 can include image and/or video analysis functionality or have access to such functionality for comparing images and/or video of the subjects for determining whether images and/or video of the subjects are substantially the same. In this example, if the images and/or video of the subjects are deemed substantially the same, then the subjects can be considered to be related.

In block 506, manager 104 can identify the discussion forum to client device 106 based on the relation of the subjects. The discussion forum can be identified to client device 106 if the subjects are deemed to be related. For example, the discussion forums managed by manager 104 and associated with the identified webpages or subjects can be presented to user 112 via client device 106. For example, referring again to FIG. 3, the discussion forum categories shown under the heading “Select Discussion Forum Category for Related Subjects” are categories associated with discussion forums that are associated with subject related to the subject automobile review webpage. In the example of FIG. 3, the numbers associated with the discussion forum category indicate whether a related discussion forum was found by manager 104 that is related to the subject automobile review webpage and associated with the respective discussion forum category. User 112 can use client device 106 to select one of the hyperlinked discussion forum categories for accessing the respective discussion forum. This feature can be advantageous, for example, because a user can select a subject (e.g., a webpage) and be provided with a listing of discussion forums for subjects related to the selected subject (e.g., other webpages related to the selected webpage). In the above example, the user can be provided with a listing of discussion forums in different categories and associated with webpages related to the selected automobile review webpage.

In one embodiment, discussion forum manager 104 can determine subjects related to a selected subject by searching previously identified subjects. For example, a selected webpage can include text identifying a particular world news event. Manager 104 can use words and/or phrases in the text for searching for other webpages having the same or similar words and/or phrases. Webpages having the same or similar words and/or phrases can be identified as a related webpage. In another example, a selected webpage can include a posting date/time (such as in the webpage's metadata or its text content) that identifies the date/time of posting of the webpage on the Internet. In this example, manager 104 can only identify a webpage as being related if the webpage has a posting date/time that is within a particular time/date period of the selected webpage. This feature can be advantageous, for example, for determining that a webpage is related if it has been recently posted with respect to the selected webpage. Further, this feature can be advantageous with respect to news events, for example, because a user may only be interested in discussion forums about a subject that closely related in time. In yet another example, a selected webpage can include video and/or images. In this example, manager 104 can use video and/or images for searching for other webpages having the same or similar video and/or images. Webpages having the same or similar words and/or phrases can be identified as a related webpage. As stated above, discussion forums associated with related webpage(s) can be identified to the user. The user can select to enter the identified related subject(s) (e.g., webpage(s)). Further, for example, the user can select to enter a discussion forum associated with the related subject(s) and associated with one of the predetermined discussion forum categories (e.g., by selecting a hyperlink such as one of the predetermined discussion forum category hyperlinks shown in FIG. 3 under the heading “Select Discussion Forum Category for Related Subjects”).

In one embodiment, a predetermined discussion forum category can specify a geographic location and/or another demographic associated with a user of a client device. The geographic location and/or demographic can be used for matching advertisers with discussion forums associated with the geographic location and/or demographic. For example, an advertiser can determine to only provide advertisements on discussion forums associated with a particular geographic location and/or demographic. An advertisement for the advertiser can be presented to a user accessing the discussion forum (such as a webpage presenting the discussion forum to the user). This feature can be advantageous, for example, for directed advertising. In another example, the advertisement can be only presented on discussion forums associated with particular subjects and/or subject having particular content. For example, a local car dealer can specify to place an advertisement on discussion forums associated with a particular automobile review website and a geographic location of a discussion forum category.

In one embodiment, a discussion forum managed by a discussion forum manager can include all or a portion of the identified subject. Some or all of the identified subject can be presented to client devices interfacing with the discussion forum. For example, if the identified subject is a webpage, some of the webpage, all of the webpage, or a link to the webpage can be provided to a client device interfacing with the discussion forum. The link can be used to access the identified subject webpage. In another example, all or a portion of media content can be presented to client devices interfacing with the discussion forum. For example, all or a portion of subject video or audio can be presented.

In one embodiment, a user can specify a root URL of a website to search for discussion forums. For example, a user may specify the root URL of http://www.edmunds.com to search for any identified subject webpages having this root.

In one embodiment, a discussion forum manager can provide alerts to client devices regarding activity of discussion forums. For example, manager 104 can provide an alert to client device 106 when a discussion forum of a specified subject and/or category has a new entry or has been created. For example, a user can select to be updated on a new entry with respect to a webpage or website. The alert can be communicated via network 108 as a text message or any other suitable technique and via any suitable network. Further, a user can select to receive alerts to new entries from another specified user.

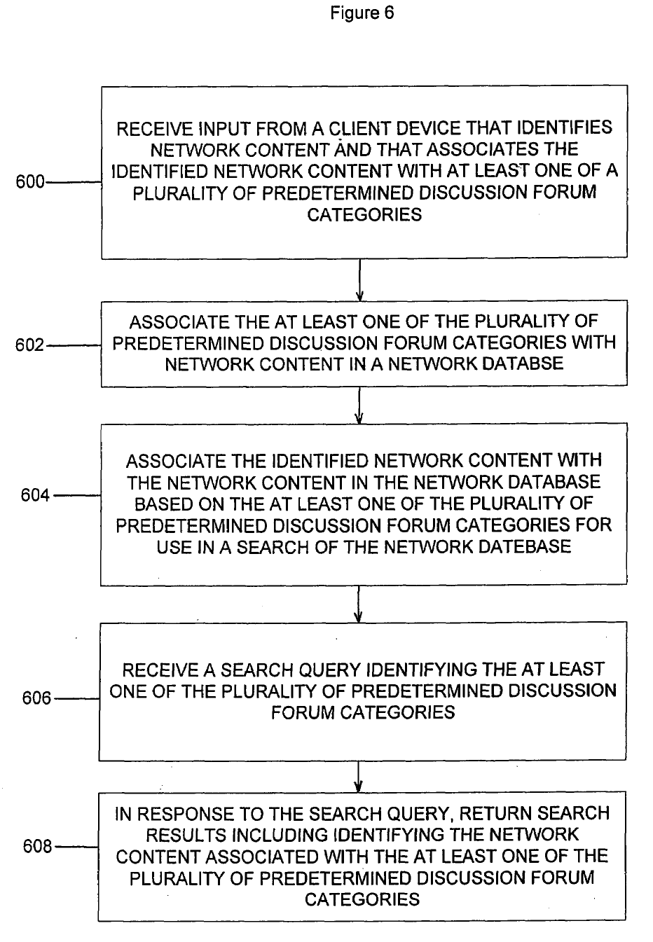

According to one aspect, a system according to the subject matter described herein can associate network content for use in performing a search of a network database. In particular, network content can be associated based on predetermined discussion forum categories and the associated can be used in a search of a network database. FIG. 6 is a flow chart of an exemplary process for associating network content for use in performing a search of a network database according to an embodiment of the subject matter described herein. Referring to FIG. 6, in block 600 manager 104 receives input from client device 106 that identifies network content and that associates the identified network content with at least one of a plurality of predetermined discussion forum categories. For example, user 112 may enter input into user interface 114 of client device 106 for identifying network content (i.e., content available via network 108). In one example, the identified network content can be a webpage or website. In this example, client device 110 can communicate a URL of the webpage or website or another suitable identifier to manager 104 via network 108. Further, client device 106 can associate the identified network content with a predetermined forum category in accordance with the other exemplary processes described herein. For example, user 112 may enter input into user interface 114 of client device 106 for selecting one or more of the predetermined categories listed on a webpage generated by discussion forum manager 104 as described in the examples provided herein. This can be advantageous, for example, because the input from the client device can identify one or more predetermined categories that have been selected by a user as being related to the identified network content. Thus, network content may be associated with a user selected discussion forum category for use in performing a search of a network and/or network database such as database 118.

In block 602, a search manager 116 of server 102 can associate the predetermined discussion forum category or categories identified in block 600 with network content in a network database 118. For example, one or more client devices can provide input for associating discussion forum categories with network content in database 118. The input can be gathered in accordance with the examples described herein. The network content stored in database 118 can be any type of content stored on a network, such as network 108. For example, the network content can be webpages and/or websites accessible via the Internet.

In block 604, search manager 116 can associate the network content identified in block 600 with the network content in network database 118 based on the predetermined discussion forum category or categories identified in block 600 for use in a search of network database 118. For example, network content can be associated with each other for use in a search based on one or more of the identified predetermined discussion forum categories. The step of associating the network content (the step(s) associated with block 604) can be automatically implemented upon receiving the input(s) associated with block 600 and associating the at least one of the categories associated with block 602). In one example, the network content can be associated with each other if each has been associated with the same predetermined discussion forum category. This can be advantageous, for example, because one or more users have identified the network content as being related. Therefore, when one of the network content is discovered in a search, the other network content can be identified to a user.

In block 606, search manager 116 can receive a search query identifying the at least one of the plurality of predetermined discussion forum categories. For example, a searcher can enter one or more of the predetermined discussion forum categories in a search query. In response to the search query, search manager 116 can return search results including identifying the network content associated with the at least one of the plurality of predetermined discussion forum categories (block 608). For example, search manager 116 can present to the searcher the network content that has been associated with the category or categories.

In one embodiment, search manager 116 can receive at least a portion of content of a discussion forum associated with network content and a discussion forum category. The at least a portion of content of the message forum can be associated with the network content in the network database. The network database can be searched, in response to a search query, based on the association of the at least a portion of the content of the message forum with the network content in the network database. For example, the content of discussion forum entries can be associated with network content of the respective discussion forum for use in a search of a network database. Further, the text or phrases of one or more entries in a discussion forum can be associated with the network content associated with the discussion forum. A searcher can enter one or more of the text or phrases, and a search manager can present to the searcher the network content that has been associated with the text or phrases. This can be advantageous, for example, because the text or phrases entered by users with respect to network content can be used for performing a search of a network database.

In one alternative to search manager receiving a search query identifying a predetermined discussion forum category, the search manager may receive a search query identifying the network content identified in block 600. In this example, the search manager can identify other network content (if any) that was associated with the identified network content in block 604. The associated network content (if any) can be communicated as search results to a user that submitted the search query. This feature can be advantageous, for example, because the search results include network content that has been associated with network content in a search query that has been identified as belonging to the same category. Further, for example, search manager 116 can be configured to automatically communicate to a client device that submitting input (such as client device in the above example of block 600) any network content associated with a category associated with the input network category.

In one embodiment, search manager 116 may receive a search query identifying any network content or portion of network content stored in database 118. In this example, the search manager can identify and return in search results to a client device other network content (if any) that was associated with the identified network content or portion of network content. For example, the network content (if any) returned in a search result can be any network content that has been associated with the identified network content or portion of network content.

In one embodiment, search manager 116 may automatically conduct a search for related discussion forums based on a subject identified by a client device and/or a predetermined discussion forum category identified by the client device. For example, the identified subject may be related to one or more discussion forums as described in examples provided herein. In this example, the content of the discussion forum(s) may automatically be communicated to the client device. For example, entries in the discussion forums may be automatically communicated and presented to the client device upon identification of the subject and/or identification of the predetermined discussion forum categories. The discussion forum content can automatically be communicated and presented via the client device in a webpage generated by server 102. Alternatively, the discussion forum content may be stored at the client device until accessed by the user. This feature may be advantageous, for example, because the user of the client device will not have to manually submit request(s) for the content.

In one embodiment, manager 104 may include or be associated with image and/or voice recognition modules configured to determine text corresponding to an image and/or audio content received from a client device. The image and/or audio can be converted to text for use in relating the content to other content in accordance with the examples provided herein.

In one embodiment, manager 104 can be configured to recognize a product within identified content and provide advertising-related content to a client identifying the content. Further, for example, a predetermined discussion forum category may be “Advertising News” in which users can provide information regarding the sale of items identified in content. In one example, users can post entries including links with sales information related to the items identified in content.

The executable instructions of a computer program for carrying out the methods illustrated in FIGS. 2A, 2B, 4A, 4B, 5, and 6 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for accessing a discussion forum, the method comprising:
(a) receiving identification of a subject from a client device;
(b) receiving selection of at least one of a plurality of predetermined discussion forum categories for accessing a discussion forum associated with the identified subject and the at least one of the plurality of predetermined discussion forum categories; and
(c) presenting the discussion forum to the client device based on the received identification of the subject and the received selection of the at least one of the plurality of predetermined discussion forum categories.

2. The method of claim 1 wherein receiving identification of a subject from a client device includes receiving identification of a subject from the client device via a network connection.

3. The method of claim 1 wherein receiving identification of a subject includes receiving identification of one of at least a portion of a website, audio content, text content, video content, photo content, at least a portion of a periodical, a product, a geographic location, and network content.

4. The method of claim 1 wherein receiving identification of a subject includes receiving one of a uniform resource locator (URL), a title of music content, a title of video content, a title of a photo, a title of a periodical, a title of a periodical article, a product name, a product uniform product code (UPC), and a name of a geographic location.

5. The method of claim 1 wherein presenting a discussion forum to the client device includes presenting the discussion forum to the client device via a network connection.

6. The method of claim 1 comprising associating the discussion forum with at least one other discussion forum associated with the selected at least one of the plurality of predetermined discussion forum categories.

7. The method of claim 1 comprising associating the discussion forum with at least one other discussion forum associated with the received identification of the subject.

8. The method of claim 7 wherein associating the discussion forum with at least one other discussion forum includes presenting the at least one other discussion forum to the client device.

9. The method of claim 1 wherein receiving identification of a subject includes receiving identification of network content, and wherein the method comprises associating the discussion forum with at least one other discussion forum associated with at least a portion of the network content.

10. The method of claim 9 wherein associating the discussion forum with at least one other discussion forum includes presenting the at least one other discussion forum to the client device.

11. The method of claim 1 comprising receiving an entry for the discussion forum from the client device.

12. A method for associating network content for use in performing a search of a network database, the method comprising:
(a) receiving input from a client device that identifies network content and that associates the identified network content with at least one of a plurality of predetermined discussion forum categories;
(b) associating the at least one of the plurality of predetermined discussion forum categories with network content in a network database; and
(c) associating the identified network content with the network content in the network database based on the at least one of the plurality of predetermined discussion forum categories for use in a search of the network database.

13. The method of claim 12 wherein receiving input from a client device that identifies network content includes receiving identification of one of at least a portion of a website, audio content, text content, video content, photo content, at least a portion of a periodical, a product, a geographic location, and network content.

14. The method of claim 12 wherein receiving input from a client device that identifies network content includes receiving one of a uniform resource locator (URL), a title of music content, a title of video content, a title of a photo, a title of a periodical, a title of a periodical article, a product name, a product uniform product code (UPC), and a name of a geographic location.

15. The method of claim 12 wherein receiving input from a client device that associates the identified network content with at least one of a plurality of predetermined discussion forum categories includes receiving, from the client device, selection of the at least one of the plurality of predetermined discussion forum categories.

16. The method of claim 12 comprising:
(a) receiving a search query identifying the at least one of the plurality of predetermined discussion forum categories; and
(b) in response to the search query, returning search results including identifying the network content associated with the at least one of the plurality of predetermined discussion forum categories.

17. The method of claim 12 comprising:
(a) receiving at least a portion of content of a discussion forum associated with the network content and the discussion forum category; and
(b) associating the at least a portion of content of the discussion forum with the network content in the network database,
wherein searching the network database includes searching the network database based on the association of the at least a portion of the content of the discussion forum with the network content in the network database.

18. A method for identifying a discussion forum associated with a subject related to a subject identified by a client device, the method comprising:
(a) associating a first subject with a discussion forum;
(b) receiving identification of a second subject from a client device;
(c) comparing at least one of content and metadata of the first subject with at least one of content metadata of the second subject for relating the first subject to the second subject; and
(d) identifying the discussion forum associated with the first subject to the client device based on the relation of the first subject and the second subject.

19. The method of claim 18 wherein the client device is a first client device, wherein associating a first subject with a discussion forum is based on:
(a) receiving identification of the first subject from a second client device; and
(b) receiving, from the second client device, selection of the discussion forum from a plurality of predetermined discussion forum categories.

20. The method of claim 18 wherein receiving identification of a second subject includes receiving one of a uniform resource locator (URL), a title of music content, a title of video content, a title of a photo, a title of a periodical, a title of a periodical article, a product name, a product uniform product code (UPC), and a name of a geographic location.

21. The method of claim 18 comprising:
(a) receiving a search query identifying one of a plurality of predetermined discussion forum categories associated with the discussion forum; and
(b) in response to the search query, returning search results including identifying the first subject and the second subject.
